(19) United States
(12) Patent Application Publication
(10) Pub. No.: US 2002/0055695 A1
(43) Pub. Date: May 9, 2002

(54) Motor-driven beauty device

(76) Inventors: Ryoichi Takahata, Hitachi (JP); Kim Houng Joong, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/791,646

(22) Filed: Feb. 26, 2001

(30) Foreign Application Priority Data
Nov. 6, 2000 (JP) 2000-342374

(51) Int. Cl. A61H 7/00

(52) U.S. Cl. 601/89; 601/46

(57) ABSTRACT

The invention provides an oscillating type beauty device provided with a plurality of tools. The oscillating type beauty device has an oscillating type motor for oscillating a movable element with respect to a stator. The oscillating type motor has a plurality of movable elements corresponding to movable blades in each of the tools. A plurality of movable elements are set to be driven by a stator. The oscillating type motor comprises an armature and a movable element capable of relatively moving with respect to the armature, the oscillating type motor has one magnetic pole teeth rows which are magnetically connected to one magnetic pole of the armature and are arranged so as to be separated into a first stage and a second stage in a substantially vertical direction to a moving direction of the movable element, and another magnetic pole teeth rows which are magnetically connected to another magnetic pole of the movable element and are arranged so as to be separated into a first stage and a second stage in a substantially vertical direction to the moving direction of the movable element, the first stage of magnetic pole teeth in the one magnetic pole teeth rows and the first stage of magnetic pole teeth in the another magnetic pole teeth row are alternately arranged with respect to the moving direction of the movable element, the second stage of magnetic pole teeth in the one magnetic pole teeth rows and the second stage of magnetic pole teeth in the another magnetic pole teeth row are alternately arranged with respect to the moving direction of the movable element, and the movable element is arranged between the one and another first stage of magnetic pole teeth rows and the one and another second stage of magnetic pole teeth rows.

### BACKGROUND OF THE INVENTION

1. Field of the Invention

The present invention relates to a motor-driven beauty device, and more particularly to a motor-driven beauty device for performing a beauty treatment in an oscillating manner by using a tool such as a shaver, a hair clipper or the like.

2. Description of the Prior Art

In a conventional oscillating type motor-driven beauty device, there have been considered oscillating type motor-driven devices having various kinds of structures. However, most of the conventional oscillating type motor-driven devices employ a structure in which a rotary machine is cut and opened so as to be driven in a linear manner.

In the oscillating type motor-driven beauty device, since the oscillating type motor in accordance with the conventional art is structured a leakage flux between an armature and a movable element is much, and a magnetic attraction force is applied to a portion between the armature and the movable element in one direction, a great load is applied to a support mechanism of the movable element, so that a strain is generated in the structure and various problems are generated.

### SUMMARY OF THE INVENTION

An object of the present invention is to provide a motor-driven beauty device in which a leakage of a magnetic flux passing through a portion between an armature and a movable element is reduced and a magnetic attraction force generated between the armature and the movable element is made small.

In order to solve the problems mentioned above, in accordance with the present invention, there is provided a motor-driven beauty device provided with a movable blade, a controller, a driver, a battery and an oscillating type motor, wherein the oscillating type motor comprises an armature and a movable element capable of relatively moving with respect to the armature, the oscillating type motor has one magnetic pole teeth rows which are magnetically connected to one magnetic pole of the armature and are arranged so as to be separated into a first stage and a second stage in a substantially vertical direction to a moving direction of the movable element, and another magnetic pole teeth rows which are magnetically connected to another magnetic pole of the movable element and are arranged so as to be separated into a first stage and a second stage in a substantially vertical direction to the moving direction of the movable element, the first stage of magnetic pole teeth in the one magnetic pole teeth rows and the first stage of magnetic pole teeth in the another magnetic pole teeth row are alternately arranged with respect to the moving direction of the movable element, the second stage of magnetic pole teeth in the one magnetic pole teeth rows and the second stage of magnetic pole teeth in the another magnetic pole teeth row are alternately arranged with respect to the moving direction of the movable element, and the movable element is arranged between the one and another first stage of magnetic pole teeth rows and the one and another second stage of magnetic pole teeth rows.

In accordance with another aspect of the present invention, there is provided a motor-driven beauty device structured such that the magnetic pole teeth of the armature are arranged with keeping a space capable of securing a stroke range of the movable element including the movable blade of the armature.

In accordance with the other aspect of the present invention, there is provided a motor-driven beauty device structured such that a hair clipper blade is provided in the oscillating type motor.

In accordance with the other aspect of the present invention, there is provided a motor-driven beauty device structured such that a blade for an armpit, a bikini line, a leg and an arm is provided in the oscillating type motor.

In accordance with the other aspect of the present invention, there is provided a motor-driven beauty device structured such that a shaving blade is provided in the oscillating type motor.

In accordance with the other aspect of the present invention, there is provided a motor-driven beauty device structured such that multiple kinds of blades are connected to the movable element of the oscillating type motor in a replacing manner.

In accordance with the other aspect of the present invention, there is provided a motor-driven beauty device structured such that a support rod is provided in a connecting portion between the movable element and the movable blade in the oscillating type motor in a freely detachable manner.

In accordance with the other aspect of the present invention, there is provided a motor-driven beauty device structured such that a spring plate is freely mounted to a connecting portion between the movable element and the movable blade in the oscillating type motor in a freely detachable manner.

In accordance with the other aspect of the present invention, there is provided a motor-driven beauty device structured such that a spring is freely mounted so as to be held between the support rods in the movable element and the movable blade in the oscillating type motor.

In accordance with the other aspect of the present invention, there is provided a motor-driven beauty device structured such that a spring is freely mounted to both ends of the movable element in the oscillating type motor.

In accordance with the other aspect of the present invention, there is provided a motor-driven beauty device, further comprising a closed loop control system constituted by the oscillating type motor, a sensor detecting a relative displacement between the armature and the movable element and a magnetic pole, a control portion feeding back a signal of the sensor, and a power drive portion.

In accordance with the other aspect of the present invention, there is provided a motor-driven beauty device structured such that A motor-driven beauty device as claimed in any one of claims 1 to 10, further comprising an open loop control system constituted by the oscillating type motor, a control portion and a power drive portion.

In accordance with the other aspect of the present invention, there is provided a motor-driven beauty device, further comprising a control system constituted by the oscillating type motor, a power drive portion, and a control portion including estimating means for detecting an induced voltage of the oscillating type motor and estimating a relative magnetic pole position between the armature and the movable element on the basis of the voltage detected value.

In accordance with the other aspect of the present invention, there is provided a motor-driven beauty device, further comprising a control system comprising the oscillating type motor, a power drive portion, and a control portion including estimating means for detecting an electric current flowing through the oscillating type motor and estimating a relative magnetic pole position between the armature and the movable element on the basis of the current detected value.

In accordance with another aspect of the present invention, there is provided a motor-driven beauty device structured such that a plurality of armatures of the oscillating type motor are arranged and a pitch between magnetic pole teeth of the adjacent armatures is set to (k·P+P/M){(k=0, 1, 2, . . . ), (M=2, 3, 4, . . . )} {in which k is a number freely selected in a range that the adjacent armatures can be arranged, M is a number of phase of the motor} when the pole pitch is set to P.

In accordance with the other aspect of the present invention, there is provided a motor-driven beauty device, further comprising a switching function that any one of a battery and an external power source is employed as a power source of the motor-driven beauty device.

The features mentioned above and the other features of the present invention will be described below.

### BRIEF DESCRIPTION OF THE DRAWINGS

FIG. 1 is a block diagram showing a basic structure of an oscillating type motor-driven beauty device in accordance with an embodiment of the present invention;

FIG. 2 is a schematic view of an oscillating type motor used in the present invention;

FIG. 3A is a schematic view showing a notion of a magnetic flux flow of the oscillating type motor shown in FIG. 2

FIG. 3B is a schematic view showing an assembly constructed by separated cores;

FIGS. 4A to 4C are schematic views showing a molded oscillating type motor shown in FIG. 2 and a support rod;

FIG. 5 is a list of a movable blade employed for the oscillating type motor-driven beauty device in accordance with the present embodiment;

FIGS. 6A and 6B are block diagrams of a control using the oscillating type motor in accordance with the present embodiment;

FIGS. 7A and 7B are block diagrams of another control using the oscillating type motor in accordance with the present embodiment;

FIG. 8 is a block diagram of an oscillating type motor-driven beauty device in accordance with another embodiment of the present invention;

FIG. 9 is a schematic view showing two oscillating type motors arranged in series;

FIG. 10 is a schematic view showing two oscillating type motors arranged in parallel;

FIG. 11 is a cross sectional view of an oscillating type motor in accordance with an embodiment of the present invention;

FIG. 12 is a time chart showing an exciting sequence of a two-phase linear motor;

FIG. 13 is a time chart showing another exciting sequence of the two-phase linear motor; and

FIG. 14 is a time chart showing the other exciting sequence of the two-phase linear motor.

### DESCRIPTION OF THE PREFERRED EMBODIMENTS

A description will be given below of embodiments in accordance with the present invention with reference to the accompanying drawings. Further, in the drawings, the constituting elements denoted by the same reference numerals are the same elements or the corresponding elements.

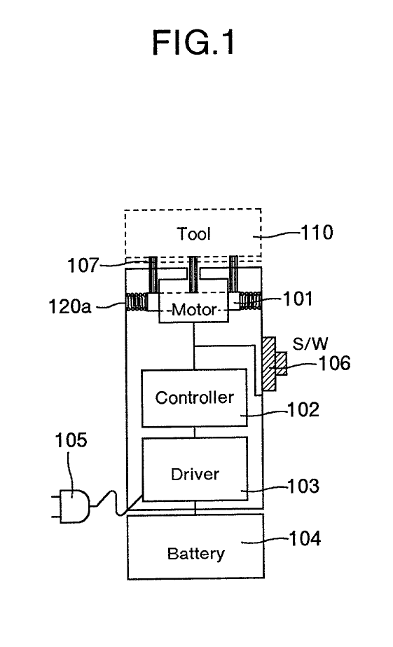

FIG. 1 is a block diagram of a basic structure of an oscillating type motor-driven beauty device in accordance with an embodiment of the present invention. Reference numeral 101 denotes an oscillating type motor constituted by an armature and a movable element mentioned below, reference numeral 100 denotes a casing, reference numeral 102 denotes a controller, reference numeral 103 denotes a driver, reference numeral 104 denotes a battery, reference numeral 105 denotes a power source code, reference numeral 106 denotes a switch, reference numeral 120a denotes a spring being in contact with the movable element, reference numeral 107 denotes a support rod, and 110 denotes a movable blade of the beauty device. The oscillating type motor device is constituted by the above elements. The structure may be made such that the oscillating type motor 101 and the movable blade 110 of the beauty device are connected to each other via the support rod 107 so as to be freely attached and detached. A spring plate may be employed in place of the support rod 107.

Further, the oscillating type motor-driven beauty device is provided with a switching function capable of being driven by both of a battery and an external power source, and the battery 104 and the power source code 105 can be attached and detached as occasion demands. Further, the springs 120a are provided in both ends of the movable element 6 in the oscillating type motor, thereby achieving a bumper function.

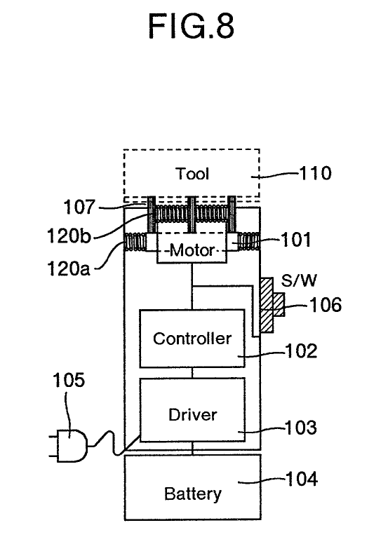

FIG. 8 is another block diagram in accordance with the present embodiment showing a structure in which a spring 120b is provided between the support rods 107 connecting the movable element 6 to the movable blade 110 with reference to the base structure shown in FIG. 1.

In FIG. 8, an efficiency of the motor-driven beauty device is increased by utilizing a resonance phenomenon of the spring 120b for an oscillating movement of the movable element 6.

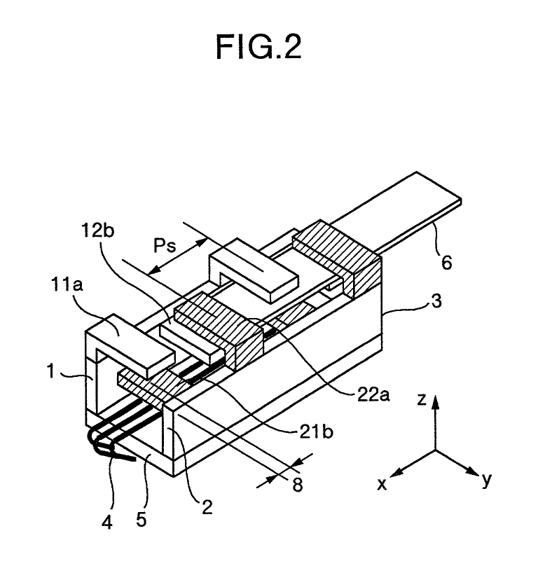

FIG. 2 shows a schematic structure of the oscillating type motor used in the oscillating type motor-driven beauty device in accordance with the present invention.

In FIG. 2, the oscillating type motor is an oscillating type motor constituted by an armature 3 and a movable element 6 relatively moving with respect to the armature 3, and the oscillating type motor further has one magnetic pole teeth row magnetically connected to one magnetic pole 1 of the armature and arranged so as to be separated into a first stage and a second stage in a substantially vertical direction with respect to a moving direction of the movable element.

Further, the oscillating type motor has another magnetic pole teeth row magnetically connected to another magnetic pole 2 of the movable element and arranged so as to be separated into a first stage and a second stage in a substantially vertical direction with respect to the moving direction of the movable element. The oscillating type motor is structured such that the first stage magnetic pole teeth of the magnetic pole teeth row provide in one of them and the first stage magnetic pole teeth of the magnetic pole teeth row provided in another thereof are alternately arranged with respect to the moving direction of the movable element, the second stage magnetic pole teeth of the magnetic pole teeth row provide in one of them and the second stage magnetic pole teeth of the magnetic pole teeth row provided in another thereof are alternately arranged with respect to the moving direction of the movable element, and the movable element is arranged between the first stage magnetic pole teeth rows in one and another and the second stage magnetic pole teeth rows provided in one and another.

In this case, an upper magnetic pole teeth 11a and a lower magnetic pole teeth 21b in the armature are defined as a first opposing portion, and a lower magnetic pole teeth 12b and an upper magnetic pole teeth 22a are defined as a second opposing portion. Accordingly, the armature is constructed so that (2n 1) th iron core becomes a first opposing portion and (2n) th iron core becomes a second opposing portion (in this case, n=1, 2, 3, . . . ).

Further, one coil 4 is received in the armature 3. There is provided an oscillating type motor structured such that the movable element 6 is held between the first opposing portions, the movable element is held between the second opposing portions, and the movable element relatively moves with respect to the armature.

In this case, the armature is constituted by an iron core, a permanent magnet, and the coil 4, and the movable element 6 may be constituted by a permanent magnet, a magnetic body and a coil combined by one kind or plural kinds of materials.

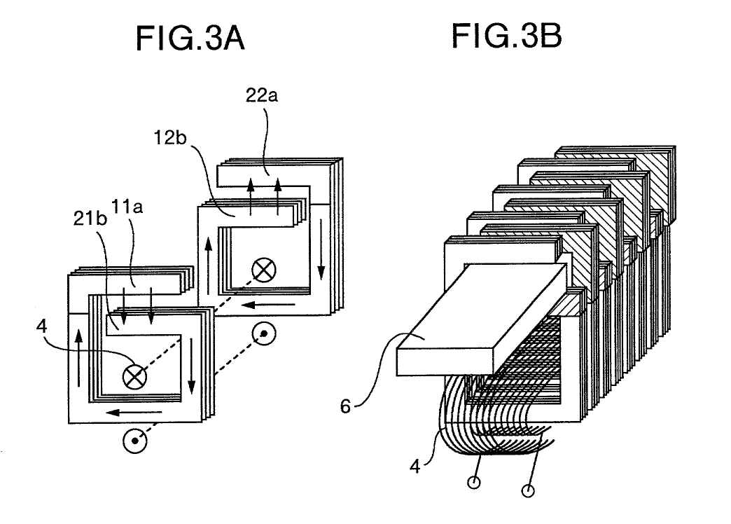

FIGS. 3A and 3B show schematic views showing a notion of the magnetic flux flow of the oscillating type motor in accordance with the present embodiment, and an assembly constructed by laminated steel plates.

When the structure is made in the manner mentioned above, as shown in FIG. 3A, the armature 3 in which the magnetic flux alternately flows in a vertical direction between the upper and lower magnetic pole teeth is formed in the gap between the upper magnetic pole teeth and the lower magnetic pole teeth in the respective opposing portions of the oscillating type motor in accordance with the present embodiment, whereby the movable element 6 relatively moves through the gap.

Further, in the oscillating type motor in accordance with the present embodiment, since an attraction force applied to the movable element 6 and the upper magnetic pole teeth and an attraction force applied to the movable element 6 and the lower magnetic pole teeth have substantially the same magnitude and the attraction forces are applied in the opposite directions, a total attraction force becomes small. Accordingly, it is possible to make the attraction force between the magnetic pole teeth of the movable element 6 and the armature 3 small, and it is possible to reduce a load of the supporting mechanism.

In FIG. 3B, the armature is constructed by laminated steel plates, and is structured such that plural sets of first opposing portions and second opposing portions are alternately arranged. Further, the magnetic pole portion having the iron core portion in which the coil of the armature is arranged and the opposing portions between which the movable element is held is separately produced by the laminated steel plates and thereafter assembled.

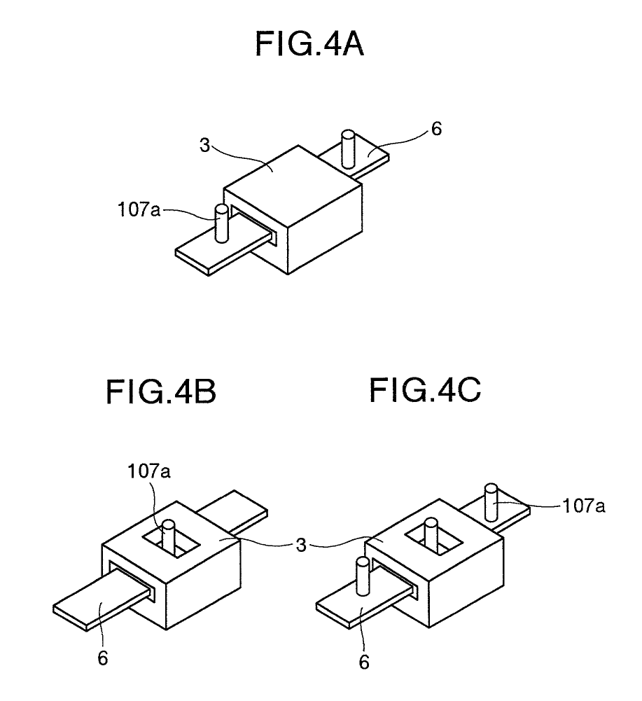

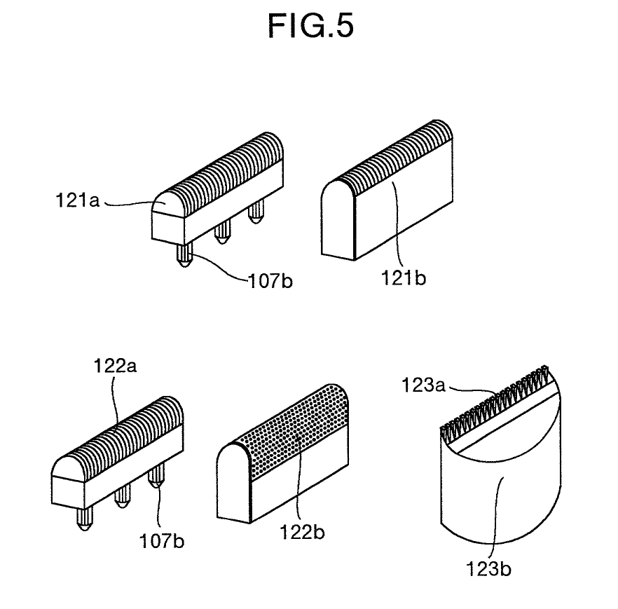

FIG. 4 shows an image of molding the armature constructed by the laminated steel plates shown in FIG. 3B.

The armature 3 is structured such as to mold so as to include the laminated steel plates, the coil and the support mechanism. FIG. 4A shows a structure in which a support rod 107a is connected to the movable element 6 in a laterally symmetrical manner, FIG. 4B shows a structure in which the movable element 6 and the support rod 107a are connected in a center portion of the armature 3, and FIG. 4C shows a structure in which the structures shown in FIGS. 4A and 4b are respectively employed. The magnetic pole teeth of the armature can be structured so as to keep a space securing a stroke range of the movable element including the movable blade of the armature shown in FIG. 2. Further, the movable blade 110 has a structure capable of being freely attached and detached. Further, the other shaped than a cylindrical shape can be employed for the shape of the support rod 107a, and a spring plate may be employed.

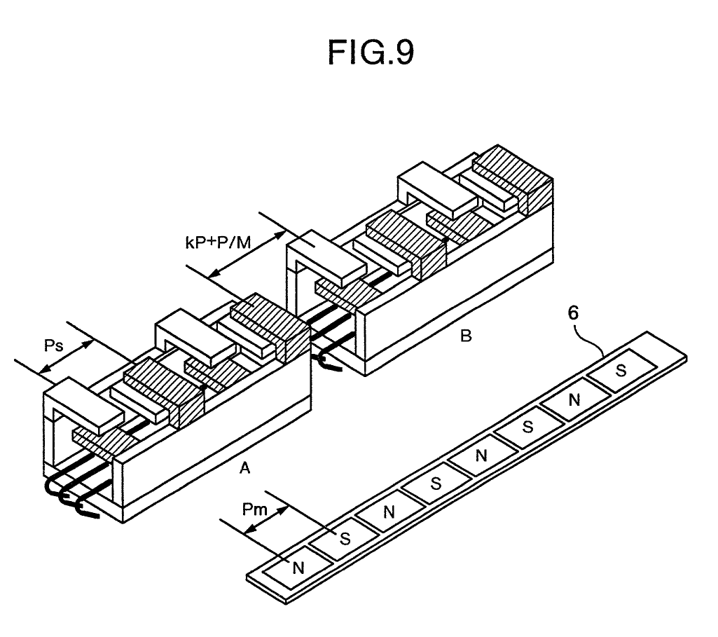

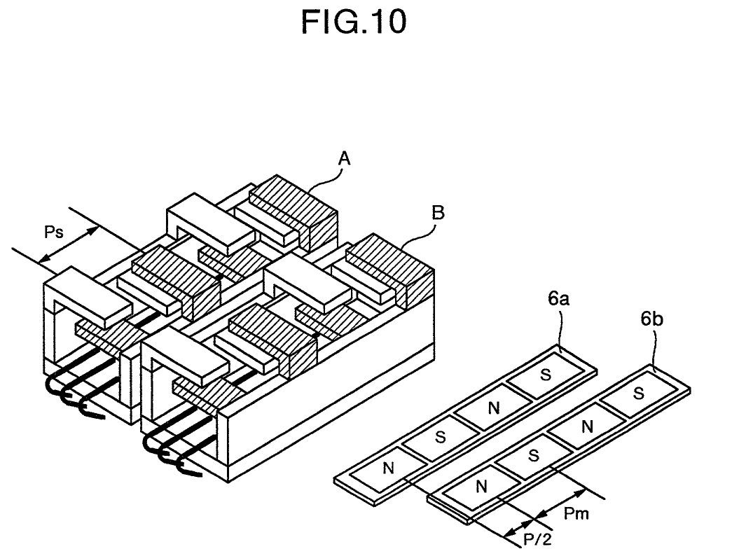

Further, the armature may be arranged in series as shown in FIG. 9 so as to be individually molded in each of a phase A and a phase B, or may be molded in a multi layer assembled manner. As shown in FIG. 10, the armature may be arranged in parallel so as to be individually molded in each of the phase A and the phase B or may be molded in a multi phase assembled manner.

FIG. 9 shows another embodiment of an arrangement of the oscillating type motor.

Here, in FIG. 9, there is shown a matter that two armatures are arranged in series. A forward moving magnetic field is generated between the phase A and the phase B by switching an exciting operation with keeping a phase difference of an electric angle 90 degrees, and the movable element 6 relatively moves. FIG. 12 shows an exciting sequence of a two-phase oscillating type motor. A moving mount and a moving speed of the forward and backward moving operation are set in accordance with conditions corresponding to the movable blade 110. Further, the switch 106 shown in FIG. 1 has a function capable of changing a moving amount, a moving speed and the like of the forward and backward moving operation.

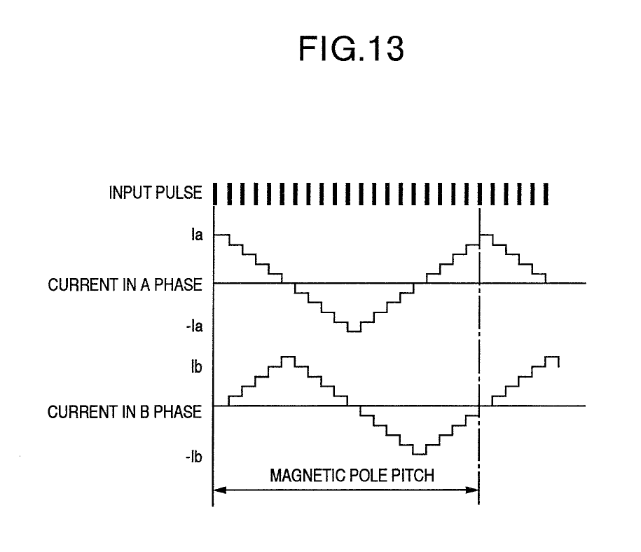

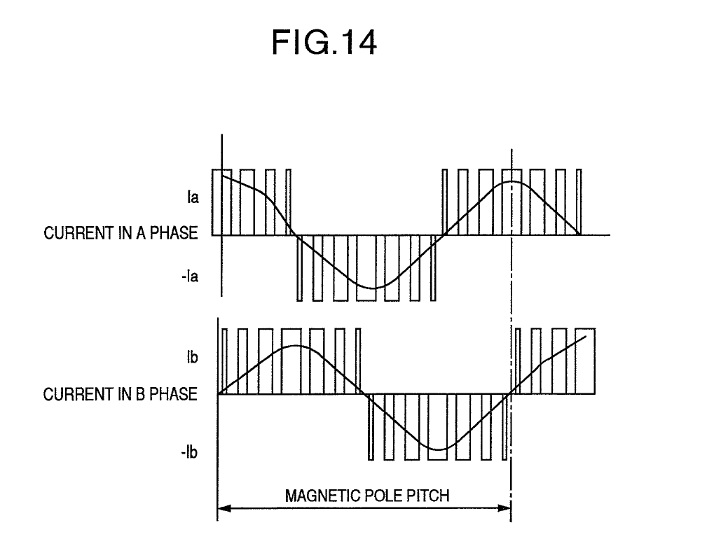

FIGS. 13 and 14 show another exciting sequence of the two-phase oscillating type motor.

FIGS. 13 and 14 shows a method of controlling a motor current to a false sine curve so as to drive a step angle of the motor in accordance with a finer step angle. Accordingly, there can be obtained an effect that a sound and a vibration can be reduced.

In accordance with a method shown FIG. 14, since a frequency control and an output voltage control are simultaneously performed by an inverter portion, an output voltage wave shape is pulse width modified so as to be formed in a sine curve. Accordingly, it is possible to remove a low level higher harmonic wave, and it is possible to reduce a propelling force ripple of the motor, so that a low speed operation can be performed.

FIG. 10 shows another embodiment of the arrangement of the oscillating type motor. In FIG. 10, there is shown a structure in which two sets of armature 3 and movable element 6 are arranged in parallel. The same matter can be applied to the case that two armatures 3 are arranged in parallel and two movable elements 6 are integrally formed, and the case that a plurality of armatures 3 are arranged in parallel and a plurality of movable elements 6 are integrally formed.

Here, the description is given of the two-phase phase oscillating type motors as the embodiments in accordance with the present invention, however, the present invention can be used as a multi-phase linear motor, for example, three-phase, four-phase and five-phase linear motors.

When a plurality of armatures 3 of the oscillating type motor are arranged and a pitch between poles is set to P, a pitch between the magnetic pole teeth of the adjacent different armatures 3 is set to satisfy the formula (k·P+P/M){ (k=0, 1, 2, . . . ), (M=2, 3, 4, . . . )} { in which k is a number freely selected among a range where the adjacent armatures 3 can be arranged, and M is a number of phase of the motor}.

FIG. 5 shows a movable blade and a cover of the oscillating type motor-driven beauty device. There are a blade 121a for an armpit, a bikini line, a leg and an arm, a cover 121b for an armpit, a bikini line, a leg and an arm, a shaving blade 122a, a cover 122b for a shaving blade, a hair clipper blade 123a, a cover 123b for a hair clipper and the like. A plurality of movable blades can be connected to the movable element so as to be used, or a plurality of armatures can be employed as shown in FIGS. 9 and 10 and a plurality of movable blades can be used by a plurality of movable elements. The support rod 107b can be connected to the support rod 107a shown in FIG. 4 and can be attached and detached. A shape of the support rod 107b can be formed in the other shape than a cylindrical shape and a spring plate may be employed.

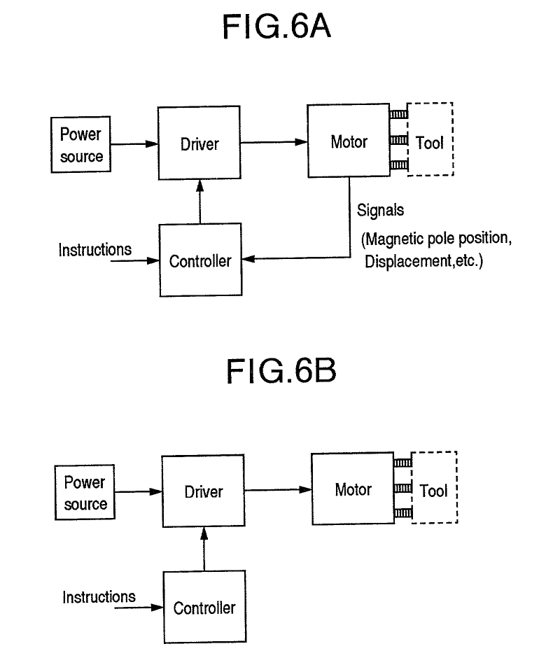

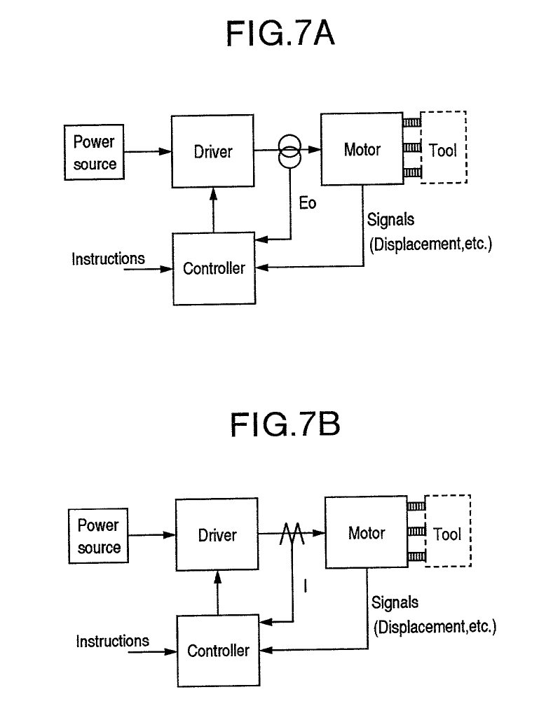

FIGS. 6A, 6B, 7A and 7B show control block diagram using the oscillating type motor in accordance with the present embodiment.

FIG. 6A shows a block diagram constituting a close loop control system comprising a sensor (not shown) detecting a relative displacement between the oscillating type motor constituted by the armature and the movable element, the armature and the movable element and the magnetic pole, the control portion feeding back signals of the sensor and the power drive portion.

FIG. 6B shows a block diagram constituting an open loop control system comprising the oscillating type motor constituted by the armature and the movable element, the control portion and the power drive portion.

FIG. 7A shows a block diagram constituting a magnetic pole sensorless control system comprising the oscillating type motor constituted by the armature and the movable element, a voltage sensor, the control portion and the power drive portion. In the present embodiment, an induced voltage generated by the oscillating type motor is read within the control portion by using the voltage sensor. A magnetic pole position is estimated from a magnitude of the induced voltage, within the control portion, and a signal for driving the oscillating type motor is output to the power drive portion. In the control system in accordance with the present structure, the oscillating type motor can be stably driven without mounting a magnetic pole position sensor in the oscillating type motor portion.

FIG. 7B shows a block diagram constituting a magnetic pole sensorless control system comprising the oscillating type motor constituted by the armature and the movable element, a current sensor, the control portion and the power drive portion. In the present embodiment, an electric current flowing through the oscillating type motor is read within the control portion by using the current sensor. Within the control portion, the induced voltage of the oscillating type motor is calculated from a voltage applied to the oscillating type motor and a detected current value, whereby the magnetic pole position is estimated and calculated. In the control system in accordance with the present structure, the oscillating type motor can be stably driven without mounting the magnetic pole position sensor to the oscillating type motor portion.

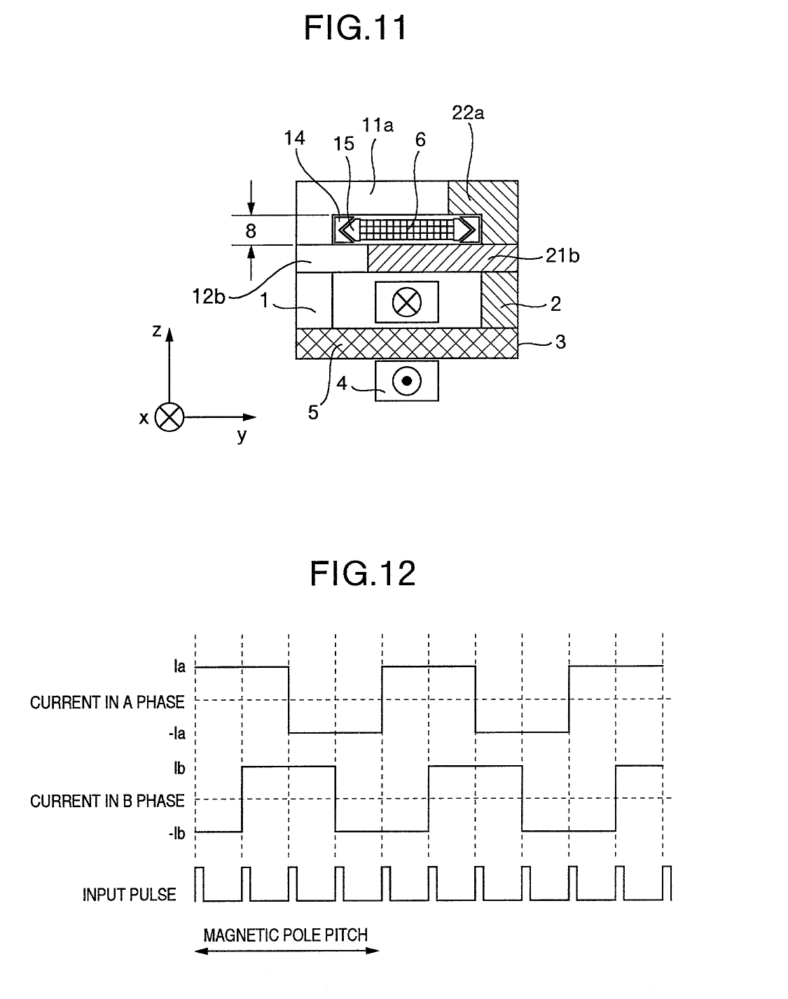

FIG. 11 is a cross sectional view of the oscillating type motor in accordance with the embodiment of the present invention. In FIG. 11, a support mechanism 14 is provided in a side of the armature 3 and a support mechanism 15 is provided in a side of the movable element 6 so as to support the movable element 6 relatively moving. Accordingly, the movable element 6 is supported by the support mechanisms 14 and 15, and relatively moves through a gap 8 so as to pass through a tunnel.

As mentioned above, in accordance with the embodiments of the present invention, the oscillating type motor can shorten a magnetic path of the magnetic circuit for an effective magnetic flux and reduce a leakage flux of the magnetic pole teeth.

Further, in the oscillating type motor in accordance with the present embodiment, since the attraction force applied to the movable element 6 and the upper magnetic pole teeth and the attraction force applied to the movable element 6 and the lower magnetic pole teeth have the same magnitude, and the attraction forces are applied in the opposite directions, the whole attraction force becomes small. Accordingly, it is possible to make the attraction force between the magnetic pole teeth of the movable element 6 and the armature 3 small, and it is possible to reduce a load of the support mechanism.

Further, it is possible to reduce the number of the parts and it is possible to make the oscillating type motor-driven beauty device thin.

In accordance with the present invention, it is possible to provide the motor-driven beauty device which can reduce a leakage of the magnetic flux passing through the portion between the armature and the movable element and make the magnetic attraction force generated between the armature and the movable element.

What is claimed is:

1. A motor-driven beauty device provided with a plurality of tools, comprising:
an oscillating type motor for oscillating a movable element with respect to a stator;
said oscillating type motor having a plurality of movable elements corresponding to movable blades in each of the tools; and
said plurality of movable elements being set to be driven by a stator,
wherein said oscillating type motor comprises an armature and a movable element capable of relatively moving with respect to the armature, said oscillating type motor has one magnetic pole teeth rows which are magnetically connected to one magnetic pole of said armature and are arranged so as to be separated into a first stage and a second stage in a substantially vertical direction to a moving direction of said movable element, and another magnetic pole teeth rows which are magnetically connected to another magnetic pole of said movable element and are arranged so as to be separated into a first stage and a second stage in a substantially vertical direction to the moving direction of said movable element, the first stage of magnetic pole teeth in said one magnetic pole teeth rows and the first stage of magnetic pole teeth in said another magnetic pole teeth row are alternately arranged with respect to the moving direction of said movable element, the second stage of magnetic pole teeth in said one magnetic pole teeth rows and the second stage of magnetic pole teeth in said another magnetic pole teeth row are alternately arranged with respect to the moving direction of said movable element, and said movable element is arranged between said one and another first stage of magnetic pole teeth rows and said one and another second stage of magnetic pole teeth rows.

2. A motor-driven beauty device as claimed in claim 1, wherein the magnetic pole teeth of said armature are arranged with keeping a space capable of securing a stroke range of the movable element including the movable blade of said armature.

3. A motor-driven beauty device as claimed in claim 1, wherein a hair clipper blade is provided in said oscillating type motor.

4. A motor-driven beauty device as claimed in claim 1, wherein a blade for an armpit, a bikini line, a leg and an arm is provided in said oscillating type motor.

5. A motor-driven beauty device as claimed in claim 1, wherein a shaving blade is provided in said oscillating type motor.

6. A motor-driven beauty device as claimed in claim 1, wherein multiple kinds of blades are connected to the movable element of said oscillating type motor in a replacing manner.

7. A motor-driven beauty device as claimed in any one of claims 1 to 6, wherein a support rod is provided in a connecting portion between the movable element and the movable blade in said oscillating type motor in a freely detachable manner.

8. A motor-driven beauty device as claimed in any one of claims 1 to 7, wherein a spring plate is freely mounted to a connecting portion between the movable element and the movable blade in said oscillating type motor in a freely detachable manner.

9. A motor-driven beauty device as claimed in any one of claims 1 to 8, wherein a spring is freely mounted so as to be held between the support rods in the movable element and the movable blade in said oscillating type motor.

10. A motor-driven beauty device as claimed in any one of claims 1 to 9, wherein a spring is freely mounted to both ends of the movable element in said oscillating type motor.

11. A motor-driven beauty device as claimed in any one of claims 1 to 10, further comprising a closed loop control system constituted by said oscillating type motor, a sensor detecting a relative displacement between said armature and said movable element and a magnetic pole, a control portion feeding back a signal of the sensor, and a power drive portion.

12. A motor-driven beauty device as claimed in any one of claims 1 to 10, further comprising an open loop control system constituted by said oscillating type motor, a control portion and a power drive portion.

13. A motor-driven beauty device as claimed in any one of claims 1 to 12, further comprising a control system constituted by said oscillating type motor, a power drive portion, and a control portion including estimating means for detecting an induced voltage of said oscillating type motor and estimating a relative magnetic pole position between said armature and said movable element on the basis of said voltage detected value.

14. A motor-driven beauty device as claimed in any one of claims 1 to 9, further comprising a control system comprising said oscillating type motor, a power drive portion, and a control portion including estimating means for detecting an electric current flowing through said oscillating type motor and estimating a relative magnetic pole position between said armature and said movable element on the basis of said current detected value.

15. A motor-driven beauty device as claimed in any one of claims 1 to 14, wherein a plurality of armatures of the oscillating type motor are arranged and a pitch between magnetic pole teeth of the adjacent armatures is set to (k·P+P/M){(k=0, 1, 2, . . . ), (M=2, 3, 4, . . . )} {in which k is a number freely selected in a range that the adjacent armatures can be arranged, M is a number of phase of the motor} when the pole pitch is set to P.

16. A motor-driven beauty device provided with a tool, comprising:
an oscillating type motor for oscillating a movable element with respect to a stator;
said oscillating type motor having a plurality of movable elements corresponding to movable blades in the tool; and
said plurality of movable elements being set to be driven by a stator,
wherein said oscillating type motor comprises an armature and a movable element capable of relatively moving with respect to the armature, said oscillating type motor has one magnetic pole teeth rows which are magnetically connected to one magnetic pole of said armature and are arranged so as to be separated into a first stage and a second stage in a substantially vertical direction to a moving direction of said movable element, and another magnetic pole teeth rows which are magnetically connected to another magnetic pole of said movable element and are arranged so as to be separated into a first stage and a second stage in a substantially vertical direction to the moving direction of said movable element, the first stage of magnetic pole teeth in said one magnetic pole teeth rows and the first stage of magnetic pole teeth in said another magnetic pole teeth row are alternately arranged with respect to the moving direction of said movable element, the second stage of magnetic pole teeth in said one magnetic pole teeth rows and the second stage of magnetic pole teeth in said another magnetic pole teeth row are alternately arranged with respect to the moving direction of said movable element, and said movable element is arranged between said one and another first stage of magnetic pole teeth rows and said one and another second stage of magnetic pole teeth rows.

17. A motor-driven beauty device as claimed in any one of claims 1 to 16, further comprising a switching function that any one of a battery and an external power source is employed as a power source of said motor-driven beauty device.
